(19) United States
(12) Patent Application Publication
(10) Pub. No.: US 2005/0176303 A1
(43) Pub. Date: Aug. 11, 2005

(54) Silicon card for reading device by applying serial advanced technology attachment interface

(75) Inventor: Chih-Mo Wu, Hsin-Dien City (TW)

Correspondence Address: TROXELL LAW OFFICE PLLC, SUITE 1404, 5205 LEESBURG PIKE, FALLS CHURCH, VA, 22041, US

(73) Assignee: Carry Computer Eng. Co., Ltd.

(21) Appl. No.: 10/618,597

(22) Filed: Jul. 15, 2003

(30) Foreign Application Priority Data
Dec. 30, 2002 (TW) 091221495

(51) Int. Cl. H01R 24/00

(52) U.S. Cl. 439/630

(57) ABSTRACT

A Silicon Card For Reading Device by applying Serial Advanced Technology Attachment Interface comprising: a Serial Advanced Technology Attachment Interface (SATAI); a First Wafer Module, a Second Wafer Module and Reading Card Unit. In this invention, SATAI is converted into an Integrated Disc Electronics Interface (IDEI) by First Wafer Module allowing the data transfer interface to change into serial interface from parallel interface. The Second Wafer Module connects with the First Wafer Module to serve in reading the Reading Card Unit with plugging external media storage. As the title indicates, the present invention comprises a Silicon Card For Reading Device with high data transfer rate, hot plugging function and effectively reducing the use of wire by applying transfer data in serial interface.

### FILED OF THE INVENTION

The present invention relates to a reading card device by applying SATA interface, typically, is a Silicon Card For Reading Device by applying Serial Advanced Technology Attachment Bus Interface to increase the data transfer rate and add the function of hot plugging.

### BACKGROUND OF THE INVENTION

FIG. 1. Shows a computer system hardware structure. It comprises: Data Processing Device 10, System Bus 20 and Media Storage 30. Data Processing Device 10 controls the performance of reading and storing the data of Media Storage 30's Advanced Technology Attachment (ATA; such as hard disc device) 31 or ATAPI (Disc device) 32. In this system, existing Bus 20 has 40 Pins or 50 Pins, and supports the Advanced technology Attachment Interface (ATAI) and Advanced technology Attachment Packet Interface (ATAPI) at the same time, that is, the media storages that connect with the system can be ATA (Hard Disc device) 31 or ATAPI (Disc device) 40. However, the Bus 20 of this system transfers data in Parallel Interface with only 3.33 MB/S-133 MB/S data transfer rate, the data transfer rate is badly slow. It can not satisfy the user's needs for transferring numerous multimedia data, also it dose not support the Hot Plugging function, user can not perform any plugging operation during the operating time. It makes user confused and results in inconvenience. Further, both of the ATA and ATAPI Bus 20 are limited by impossibility of distance data transfer, so that the length of its Bus line is only 40 cm, and when motherboard is connected with ATA and ATAPI in serial interface, there is chaos with bus lines twisted together within the host computer. Additionally, it is know that prior designs of SATA are Point-to-Point, and can only be used to transfer signals as a single device on the single signal node, and cannot transfer signals to more than two devices on the single signal node. These disadvantages result in inconvenience and confusing the user.

### THE PURPOSE OF THE INVENTION

The main object of the invention is to provide a Silicon Card For Reading Device by applying SATA Interface, specifically a device that takes advantages of SATA Bus interface to dramatically increase the data transfer rate, reduce the wire use and add Hot Plugging design to allow user to perform plugging operation while the electric power is turned on. It also provides a feature that directly uses various external media storages that include memory cards such as, CF type I/II Card, ATA Flash Card, ATA Device, Micro Drive, SD, RS MMC, MMC, MS, MS Duo, SM, xD through this reading device.

As described above, this invention comprises SATAL; The First Wafer Module; The Second Wafer Module; and Reading Card Unit. The SATAI has 7PIN-plugging ports, and is used to connect with external SATA Bus; Further, the SATAI connects with the First Wafer Module allowing the SATAI to be converted into IDEI through the First Wafer Module. The Second Wafer Module processes the output control, programming of the Reading Card Unit and reading the media storage. The Reading Card Unit has at least two different types of plugging ports allowing external media storages plug in and out, so that the reading device by applying SATA has a controllable interface with double slots.

According to the description above, the First Wafer Module and the Second Wafer Module can be integrated into a central Wafer Module by taking IC structure and packet technology in order to simplify the electro circuit design and reduce the cost of manufacturing.

### THE PREFERABLE EMBODIMENTS OF THE PRESENT INVENTION

FIG. 2. Shows a preferable example of implementing this invention. The system structure of the Silicon Card For Reading Device has been displayed. The Silicon Card For Reading Device 100 comprising:
A SATAI 160 that is installed inside Silicon Card For Reading Device 100 connects with a Data Processing Device 10 by a SATA Bus 180 allows Reading Device 100 and Data Processing Device 10 to store and read data from each other. This SATAI 160 can be designed as the interface with 7 PIN plugging ports and connecting with the external SATA Bus 180.

The Data Processing Device 10 as described above can be Desktop, Notebook, PDA, palm Data Processing Device, IA home applicants, and panel computer etc.

The First Wafer Module 110 is used to convert SATAI 160 into IDEI 170 when it connects with the Data Processing Device 10 so that the data transfer interface changes to serial interface from parallel interface.

The Second Wafer Module 120 connects with the First Wafer Module 110 to process the input and output controlling, programming of Reading Card Unit 130 of Processing Reading Device 100, and reading the external plugging media storage. Once it receives the connected signal as described above, it will be in waiting state and examine the utilization of the media storage at any moment.

The media storage as described above generally means the devices that can be supported by Reading Card Unit 130.

Reading Card Unit 130 comprises at least two plugging slots allowing external devices to set in Silicon Card For Reading Device 100. Wherein:
The First plugging slot 140 can be designed as a PCMCIA and/or CF interface allowing to support ATA Device, ATA Flash Card, Compact Flash card type I/II, Micro Drive etc;
The Second Plugging Slot 150 can be designed as a particular interface device allowing to support one of SD, MMC, RS MMC, MMC ROM Card, MS, MS Duo, MS Stick ROM Card, SM, SM ROM Card, XD; or the Second Plugging slot can be designed as combined interface so that the various memory cards can be used at the same or different times;
The First Plugging Slot 140 and The Second Plugging Slot 150 control their working time through The Second Wafer Module 120.

The means that the Second Wafer Module 120 uses the Reading Card 130 can be either single using the first plugging slot 140, the second plugging slot 150, or using any repetitions of the First Plugging slot 140 and the Second Plugging Slot 150 at the same time.

Moreover, a Switch Unit 300 can be added to the Silicon Card For Reading Device 100 to provide a function of hand switching through using the First Plugging Slot 140 and the second Plugging Slot 150 by user.

FIG. 3. displays another example of the invention. It shows the graph of the system structure of the Silicon Card For Reading Device. In this example, the First Wafer Module integrates with the Second Wafer Module to form a Central Wafer Module by IC structure and Packet Technology so as to simplify the electro circuit design of reading card device and reduce the cost of manufacturing. The Silicon Card For Reading Device 200 comprises:
SATAI 250, which is installed inside the Reading Device 200, can connect with the Data Processing Device 10 by a SATA Bus 180 allowing Reading Device 200 and Data Processing Device 10 to transfer data from and to each other, and also generates a connected signal to announce that the Reading Device 200 has been connected with the Data Processing Device 10.

The SATAI 250 can be a connector with 7 PIN connects with SATA Bus 180.

The Central Wafer Module, which connects with SATAI 250 to change the data transfer interface from parallel interface to serial interface, also controls the input/output, programming of the Reading Device 200 and examines the Reading Card Unit. Once it receives the connected signal that sent from SATAI 250, the Central Wafer Module would be in waiting status, and examine the utilization of the Reading Cell.

The Reading Card Unit 220 is used to connect with its external media storage and has at least two plugging slots allowing the Reading Device 200 to connect with its external media storage 200, wherein:
The First Slot 230 can be designed as a PCMCIA or CF interface allowing to support ATA Device, ATA Flash Card, Compact Flash Card type I/II, Micro Drive etc;
The Second Slot 240 can be designed as a particular interface allowing to support SD, MMC, RS MMC, MMC ROM Card, XD etc, or designed as a combined interface in order to use various memory cards at the same or different times. The First Plugging Slot and The Second Plugging Slot control their working time through the Central Wafer Module 220.

The means that the Central Wafer Module uses the Reading Card Unit 220 can be either single using the First Plugging Slot 230, The Second Plugging Slot 240 or using the repetition of anyone of the First Slot 230 and the Second Slot 240 at the same time.

Moreover, a Switch Unit 300 can be added to the Silicon Card For Reading Device 200 to provide a function of automatically switching between using the First Plugging Slot and the Second Plugging Slot by user, that is, provides a hand switching function.

Further, the Reading Card of this invention also can be designed as single plugging interface by applying CF interface.

To sum up, this invention of the Silicon Card For Reading Device by applying SATAI takes advantages of the SATA Bus' characters to greatly increase the data transfer rate, reduce wire use, add the hot plugging function thus allowing user to connect with the working device while the electric power is on, and directly use various external media storages through a single Silicon Card For Reading Device. It has distinctive features that have never existed in prior designs. It truly meets the key requirements for applying paten right, so please examine and verify this invention and grant the patent right to benefit publics.

The technology, drawing and graphs, procedures or the means of control as described above are only one of the preferable implementing examples of the invention. The similar creations that make equal change or add no necessary decorations or take a part of the functions from this invention are covered by the scope of this invention claims, and the implementing scope of this invention can not be limited by the preferable example as described above.

### THE BRIEF DESCRIPTION OF THE DRAWINGS

FIG. 1. Shows present computer system hardware structure

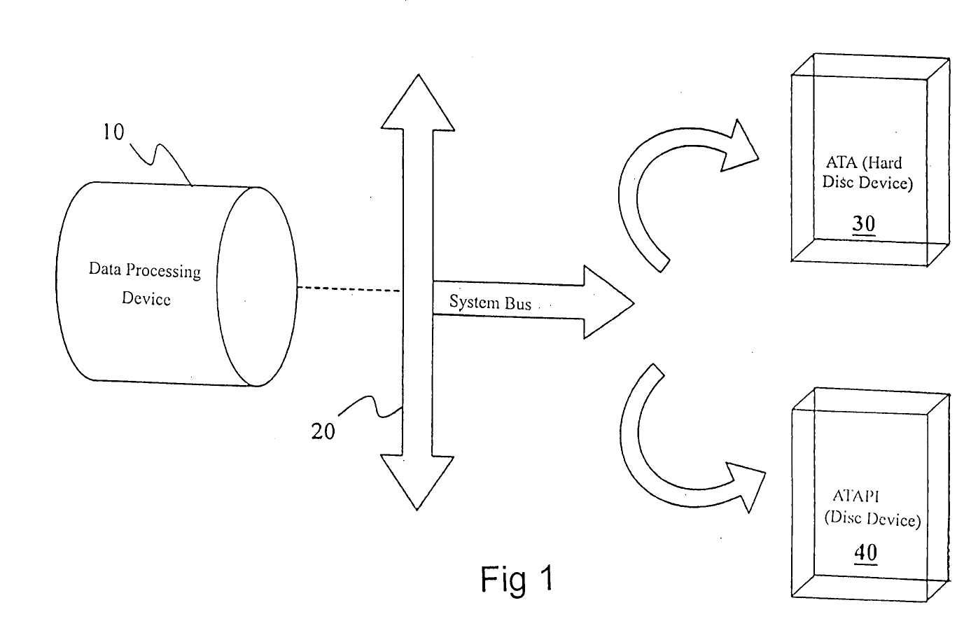

FIG. 2. Shows an example of implementing this invention, it displays Silicon Card For Reading Device system structure

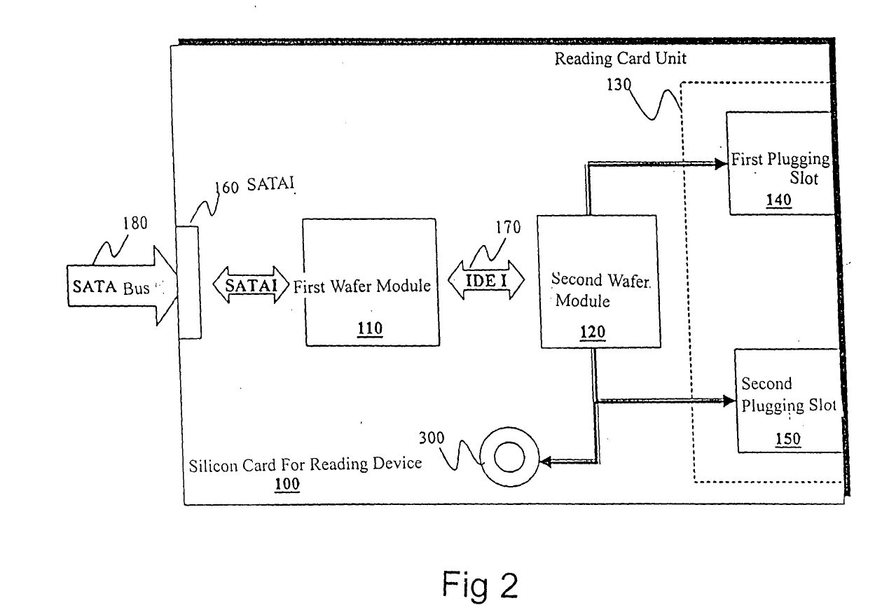

FIG. 3. Depicts another example of this invention, it shows Silicon Card For Reading Device system structure.

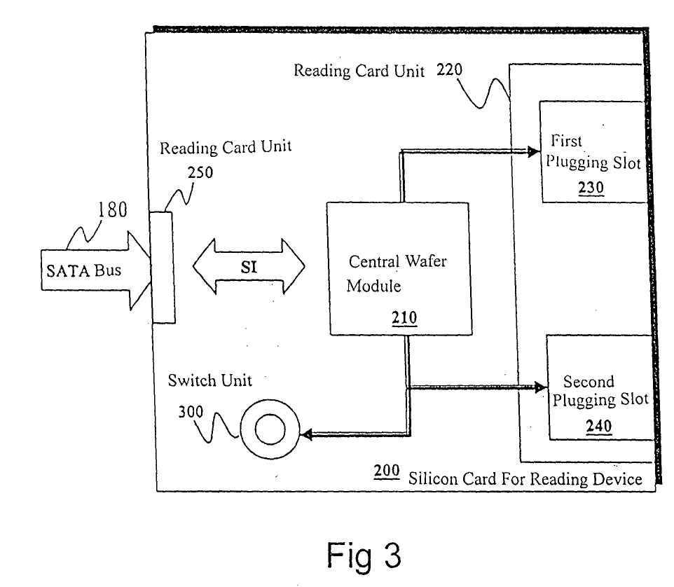

### THE DESCRIPTION OF THE SYMBOLS OF THE DRAWINGS

10 Data Processing Device
20 System Bus
30 ATA (Hard Disc Device)
40 ATAPI (Disc Device)
100 Silicon Card For Reading Device
110 First Wafer Module
120 Second Wafer Module
130 Reading Card Unit
140 First Plugging Slot
150 Second Plugging Slot
160 SATAI
170 IDEI
180 SATA bus
200 silicon card for reading device
210 central wafer module
220 reading card unit
230 first plugging slot
240 second plugging slot
250 reading card unit
300 switch unit

1. A Silicon Card For Reading Device by applying SATA comprising:
a SATAI that connects with a Data Processing Device generates a connected signal to the First Wafer Module;
a first Wafer Module converts the SATAI into the IDEI when it receives the connected signal and generates a converted signal to the Second Wafer Module;
a Second Wafer Module connects with the First Wafer Module to process the input and output controlling, programming of the Silicon Card For Reading Device, and reading the external plugging media storage. Once it receives the connected signal as described above, it will be in waiting state and examine the utilization of the media storage at any moment;
a reading Card Unit connects with the Silicon Card For Reading Device's external media storage and supports at least two Plugging Slot allowing external media devices to connect with Silicon Card For Reading Device.

2. The Silicon Card For Reading Device by applying SATAI according to claim 1 wherein the SATAI can be a connector with 7 PIN and connects with the SATA Bus.

3. The Silicon Card For Reading Device by applying SATAI according to claim 1 wherein the Reading Card Unit Comprising:
a First Slot can be designed as a PCMCIA or CF interface allowing to support ATA Device, ATA Flash Card, Compact Flash Card type I/11, Micro Drive etc;
a Second Slot can be designed as a particular interface allowing to support one of SD, MMC, RS MMC, MMC ROM Card, XD etc, or designed as a combined interface in order to use various memory cards at the same or different times;
a First Plugging Slot and the Second Plugging Slot control their working time through the Second Wafer Module 220.

4. The Silicon Card For Reading Device by applying SATAI according to claim 1 or 3 wherein the means that the Second Wafer Module uses the Reading Card can be either single using the first plugging slot, the Second Plugging slot, or using repetition of anyone of the First Plugging Slot and the Second Plugging slot at the same time.

5. The Silicon Card For Reading Device by applying SATAI according to claim 1 or 3, a Switch Unit can be designed to add to the Silicon Card For Reading Device to provide a function of automatically switching between using the First Plugging Slot and the Second Plugging Slot by user.

6. The Silicon Card For Reading Device by applying SATAI comprising:
a SATAI that connects with a data Processing Device and generates a connected signal to the First Wafer Module;
a Central Wafer Module that connects with SATAI and is used to process the input and output controlling, programming of the Reading Device, and reading the external plugging media storage. Once it receives the connected signal, it will be in waiting state and examine the utilization of the media storage at any moment;
a Reading Card Unit that is used to connect with its external media storage and comprises at least two plugging slots so that its external media storage can connects with it; accordingly, a Silicon Card For Reading Device for data transfer in serial interface is assembled.

7. The Silicon Card For Reading Device by applying SATAI according to claim 6 wherein the SATAI can be an interface with 7 PIN and connects with the SATA Bus.

8. The Silicon Card For Reading Device by applying SATAI according to claim 6 wherein the Reading Card Unit comprising:
a First Plugging Slot that can be designed as a PCMCIA or CF interface allowing to support ATA Device, ATA Flash Card, Compact Flash Card type I/II, Micro Drive etc;
a Second Slot can be designed as a particular interface allowing to support one of SD, MMC, RS MMC, MMC ROM Card, XD etc, or designed as a combined interface in order to use various memory cards at the same time or different time.
a First Plugging Slot and The Second Plugging Slot as described above control their working time through the Central Wafer Module 220.

9. The Silicon Card For Reading Device by applying SATAI according to claim 6 or 8 wherein the means that the Central Wafer Module uses the Reading Card Unit can be either using only the First Plugging Slot, the Second Plugging Slot, or using repetition of anyone of the First Plugging Slot and the Second Plugging Slot at the same time.

10. The Silicon Card For Reading Device by applying SATAI according to claim 6 or 8 wherein the Reading Device provides a Switch Unit to switch using plugging slot between the First Plugging Slot and the Second Plugging Slot by user.

11. The Silicon Card For Reading Device by applying SATAI according to claim 1 or 6 wherein the Reading Cell can be designed as the interface with single plugging slot by applying CF interface.
